(19) United States
(12) Patent Application Publication
(10) Pub. No.: US 2005/0273297 A1
(43) Pub. Date: Dec. 8, 2005

(54) Method and apparatus for describing and simulating complex systems

(75) Inventor: Frederic S. Young, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Chroma Group, Inc. (a California Corporation), San Bruno, CA (US)

(21) Appl. No.: 11/187,732

(22) Filed: Jul. 21, 2005

Related U.S. Application Data
(63) Continuation of application No. 09/401,681, filed on Sep. 23, 1999, now abandoned.

(51) Int. Cl. G06F 17/10

(52) U.S. Cl. 703/2

(57) ABSTRACT

A method for description and simulation based on organizing data into maps of invariants, the invariants being points of energy balance in a system of interest which is either in a stationary state or in a transitory disturbed state. The method includes identifying invariants in the system of interest by identifying primary sources and sinks of energy, identifying secondary energy sources and sinks coupled to the primary sources and sinks, and coupling all such sources and sinks into a network of transformations organized around nodes of those sources and sinks corresponding to the invariants, each of the nodes being characterized by a locally defined principle of balanced self-organization in a system with both a conservation law and energy dissipation. Such a system becomes “organized” upon achievement of a critical rate of entropy flux into the environment. Associated with each invariant are response rates related to energy transfer rates into and out of the invariants. The invariants are mathematically similar to the critical point found in equilbrium systems that undergo second order phase transitions.

### CROSS-REFERENCES TO RELATED APPLICATIONS

The present application claims benefit under 35 USC 19(e) and is a continuation of U.S. application Ser. No. 09/401,681 filed Sep. 23, 1999, the content of which is incorporated herein by reference in its entirety.

### BACKGROUND OF THE INVENTION

This invention relates to symbolic representation of data for both static and dynamic analysis and manipulation. In particular, the invention relates to methods and apparatus for modeling n-dimensional complex systems and networks, including biological systems, social systems, geological formations and processes and simulations thereof. This invention employs a visual calculus of complex systems alluded to in the Ph.D. dissertation of the present inventor entitled “Determination and Stabilization of the Bacterial Growth Rate,” by Fredric S. Young, University of Michigan, 1977.

Prior work including the aforementioned dissertation of the present inventor failed to suggest anything beyond a simple modeling of simple cellular processes in simple single prokaryotic cell types which include bacteria, and prior work has failed to describe or suggest how cells might interact in multicellular organisms. The dissertation of the present inventor was a theory of the computational processes of bacterial cells in natural and synthetic environments. This dissertation was an early effort in what has now come to be known as bioinformatics. Since all multicellular organisms important in medicine and physiology contain the much more complicated eukaryotic type cells, the prior work was not applicable to models other than simple bacterial cells.

In a parallel development, Per Bak at Brookhaven National Laboratories proposed a general model for complex systems to explain the ubiquitous occurrence of fractal structures and fractal (1/f) noise in a wide variety of physical and other natural systems.

It has been observed that certain non-equilibrium processes cannot be described and analyzed with sufficient mathematical clarity with current mathematical tools. Efforts have been made in recent years to develop the mathematics of nonlinear systems using nonlinear dynamics and complexity theory. An interesting and major lesson learned from the dissertation research of the present inventor and the later research in non-linear dynamics is that there are simple alternatives to conventional differential equation based simulation that can capture the essence of a complex system in a greatly simplified or “toy” model.

What is needed are techniques and devices to exploit these discoveries for description and ultimately simulation in some of the most economically significant applications and problems in geology, biology and economics. Simulation models can then be substituted for laboratory and field research to guide diagnosis and therapy development in medicine, data processing and decisionmaking affecting the acquisition and development of natural resources.

### SUMMARY OF THE INVENTION

According to the invention, a method for description and simulation based on organizing data into maps of invariants, the invariants being points of entropy balance in a system of interest which is either in a stationary state or in a transitory disturbed state. The method includes identifying invariants in the system of interest by identifying primary sources and sinks of energy, identifying secondary energy sources and sinks coupled to the primary sources and sinks, and coupling all such sources and sinks into a network of transformations organized around nodes of those sources and sinks corresponding to the invariants, each of the nodes being characterized by a locally defined principle of balanced self-organization in a system with both a conservation law and energy dissipation. Such a system becomes “organized” upon achievement of a critical rate of entropy flux into the environment. Associated with each invariant are response rates related to energy transfer rates into and out of the invariants.

The invention is based on the discovery that all systems subject to input of any source of energy are rendered stable where the conserved quantity is at a local “angle of repose,” that is, where all input rates and output rates are balanced with respect to energy input and dissipation. Systems organized in this manner exhibit either first or second non-equilibrium phase transitions. Systems with second order phase transitions have critical points whose properties are mathematically related to the critical points found in select rare equilibrium systems that undergo second order phase transitions, such as systems that have a point separating three phases, as shown in a physical phase diagram. (Examples include pressure/temperature effects on water and on carbon dioxide.) Invariants are conserved ratios reflecting the local angles of repose that result from the conservation of quantities in a dissipative system. These invariants associated with critical ratios can be described using the mathematics of percolation to describe the dynamics at the critical point.

Experimental studies of self-organization have shown, in contrast to the suggestion of Bak, that generic non-equilibrium self-organization is most likely to organize systems at first order and not at second order phase transitions. Self-organization at second order phase transitions can be achieved by incorporating extremum principles allowing selection for maxima and minima in energy dissipation and optimization. A system organized at a first order phase transition can be brought to the critical point of a second order phase transition by including feedback for optimization. The subset of systems containing second order critical points includes both living and non-living systems. According to the invention, the critical points in living systems are stabilized by a unique form of double reciprocal feedback.

According to one application of the invention, a method is provided for controlling the engineering of a complex system by creating a database based on a series of steps beginning with a description of a structure, organism or system to be created which was obtained by tracking flow of energy and transformation of “atomic” (undivisible) elements into complex structures along a reaction chain; then, given such a description of a structure, recognizing that it is a self-organizing model of the complex system which could have either a first order or a second order phase transition and that the scope of behaviors of the system is limited by the description. (A first order phase transition has no critical point, whereas a second order phase transition has a critical point in which at least three phases co-exist: i.e., solid, liquid and gas.) This is responsible for the phenomenon of universality wherein a great number of systems exhibit common behavior as evidenced in power laws describing energy scaling in systems that are valid over a huge range of scales. Knowing that non-equilibrium systems can only become balanced in a system with a phase transition of the first order or of the second order, and knowing that all living systems are characterized by biological regulatory mechanisms that are stabilized at the second order phase transition point using a double feedback mechanism, it follows that all living systems have a pattern of allowable behaviors that can be predicted and thus designed.

The present invention is a nontrivial extension of the Ph.D. work of the present inventor to n-dimensional analysis and from the growth of bacteria to homeostasis in all biological systems as well as stationary states in all systems not in equilibrium (that is, systems subject to input and dissipation of energy).

In a specific embodiment as an example of a workflow description, each invariant may be modeled as a storage element having an activated or energized state and an inactive or unenergized state with an internal mechanism for transitioning over a time scale between the two states, with unidirectional flow of energy through every storage element. The invariant is mechanically modeled as two variable-rate one-way valves connected through an accumulator, wherein the net flow of all valves in a system must be zero in the stationary (undisturbed) state. This condition of net flow of N valve sets equaling zero can thus be satisfied only when each valve set in the network is at a local critical point. In other words, at each invariant there is a fixed relationship between the flow of each valve set in the network and the percentage of the energy stored in the energy storer. This relationship can be completely defined whenever a dissipative system can be associated with a conserved quantity.

Organizing a simulation around invariants produces a set of constraints which allows the development of minimally complex representations of any system of interest.

One of the advantages of the invention is the provisions a nearly absolute reference framework for organizing any additional data into the simulations. In the examples of homeostatic regulation in biology, the inventive method of organization of a simulation provides a method of vastly streamlining the work involved in the human genome project.

The invention will be better understood by reference to the following detailed description in connection with the accompanying drawings.

### BRIEF DESCRIPTION OF THE DRAWINGS

FIG. 1 is a multiscale spatial static dataset as might be derived by applying pattern recognition techniques to geological data and illustrates three levels of scale in the indexing of the tree and three frequencies of branching events at each of the levels.

FIG. 2A-FIG. 2F is an illustration of the first five levels of a fractal of the type known as a space filling curve illustrating the case where levels are homogeneously distributed.

FIG. 3 is an illustration of the first four levels of a fractal of the type known as a space filling curve illustrating the case where levels are not homogeneously distributed.

FIG. 4 is multilevel fractal curve drawn as a one dimensional temporal dataset.

FIGS. 5A and 5B is an illustration of a result of a process according to the invention.

FIG. 6 is an illustration of a tool employed in a first step in a process according to the invention.

FIG. 7 is a flow chart of the method for fractal modeling according to the invention.

FIGS. 8A and 8B is a flow chart of workflow process development according to the invention.

FIG. 8 is an apparatus according to the invention.

FIG. 9 is a multidimensional network of superposed multilevel objects according to the invention.

FIG. 10 is a diagram of a multidimensional network of a plurality of nodes of the type of FIG. 9.

### DESCRIPTION OF SPECIFIC EMBODIMENTS

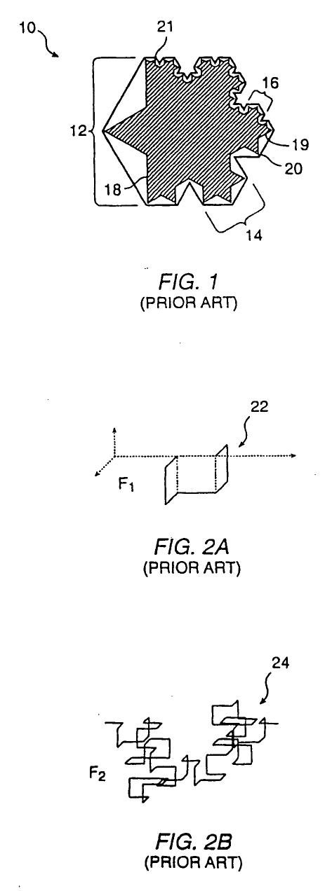

In order to understand the invention, it is useful to define the underlying elements. Referring to FIG. 1, there is illustrated a graphical representation of a typical multiscale spatial static dataset 10 as might be derived by applying pattern recognition techniques to geological data. It illustrates three scale levels 12, 14, 16 in the indexing of the tree. Each scale level has three branching event frequencies. (At each increase in scale, to each source line 18, 19 is added a corresponding triangle 20, 21 resulting from events at the third harmonic of the source line.) This dataset 10 is a multiscale fractal, meaning that the fractalization process is not applied homogeneously at each scale. For the purposes of explanation, the pattern shown is totally regular, each level is of the same exponential. An example of an irregular pattern would be the boundary of a seacoast viewed at different scales. However, each level would be covered by a range of exponentials. The dataset 10 has the same characteristics of any dataset derived from an appropriate pattern recognition system which can yield labeled textures. An example of a suitable pattern recognition system is described in U.S. patent application Ser. No. 09/070,110 filed Apr. 29, 1998. Other pattern recognition systems may provide similar results.

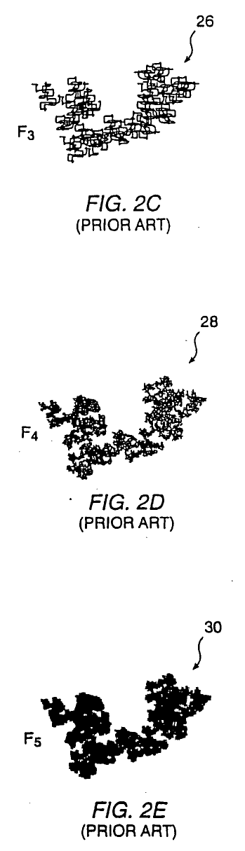

FIG. 2A-FIG. 2F are illustrations of the first five levels 22, 24, 26, 28, 30 of a fractal of the type known as a space filling curve illustrating the case where levels are homogeneously distributed. This illustration of a multilevel space-filling curve. Multi-level space-filling curves can be combined with other types of curves as hereinafter explained. The process of progressing through each of the levels is called fractalization.

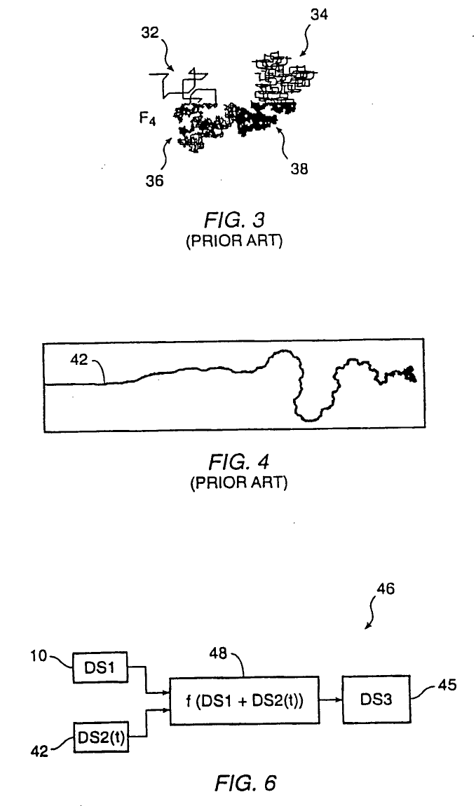

FIG. 3 is an illustration of the first four levels 32, 34, 36, 38 of a fractal 40 of the type known as a space filling curve illustrating the case where levels are not homogeneously distributed. The process of producing this fractalization is a variant of the type shown in FIG. 1, operating on each line segment of FIG. 2A-2F. The output of a pattern recognition system yielding labeled textures would be as illustrated in FIG. 3.

FIG. 4 illustrates a multilevel fractal curve 42 drawn as a one-dimensional temporal dataset wherein the local density of the curve is a measure of the level of fractal branching of the type of process shown in FIG. 2A-2F. Thus the fractal 42 is a combination of a one dimensional multilevel temporal dataset and a space filling curve.

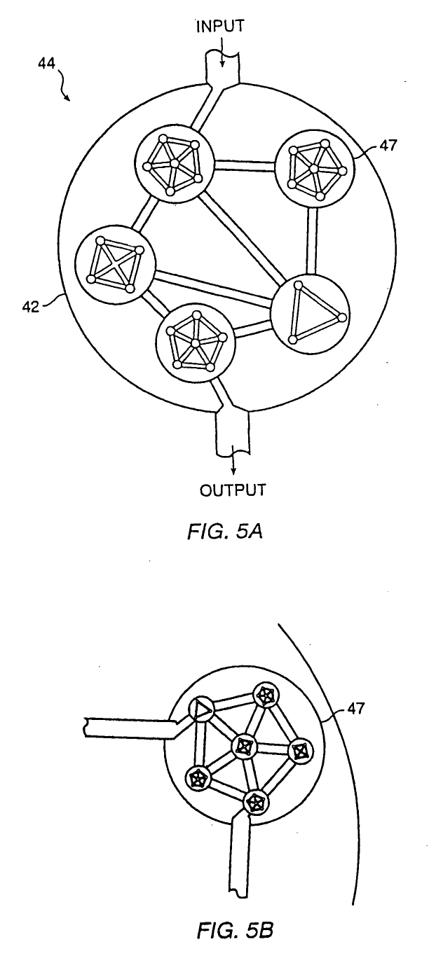

FIGS. 5A and 5B are an illustration of a result of an environmental process 44 which is a superposition of temporal processes 42 and the datasets previously described. This illustrates how objects defined as labeled textures may process throughputs, and it represents a graphical description of a physical process analyzed according to the invention. The multiscale nature of the process should be evident from the illustration, which shows the magnification in FIG. 5B of one of the processes 47 as having the same characteristics and structure as the process 42 in FIG. 5A from which it is magnified.

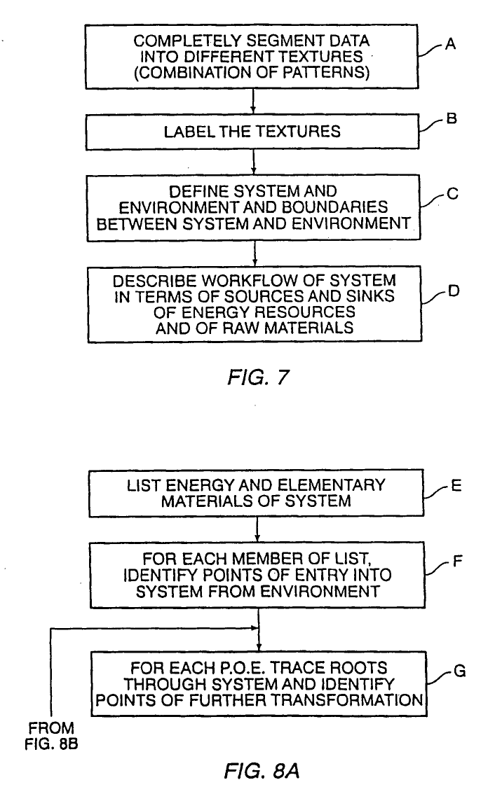

FIG. 6 is an illustration of a system 46 for producing the description or simulation 45 according to the exact transformation process 48 of the invention. The inputs to the process 48 are the three dimensional fractal dataset DS1 10 of FIG. 1 and the one-dimensional temporal dataset DS2(t) 42 of FIG. 4. A computer program operative according to the inventive process 48 would produce the four dimensional simulation set DS3 or description 45 in accordance with the invention. Not shown but which should be understood is that the output product 45 can produce a second completely orthogonal one-dimensional temporal dataset which may be the basis of feedback to each dimension of the input datasets 10 and 42, changing both the temporal and organizational characteristics of the transformation process 48. (This feedback is not illustrated in FIG. 6, for simplicity, because it would be in a dimension not readily illustrated in the dimensional depiction of FIG. 6. However, such depiction could be modeled in grayscale or color.) This second one-dimensional dataset can be a mapping of other higher dimensional information. A pair of related four dimensional datasets of space and time 1 and space and time 2 would constitute a six dimensional dataset.

FIG. 7 is a flow chart of the process 48 for fractal modeling according to the invention. The process begins by a gross form of data compression, namely, the segmenting the data into different textures (Step A). Textures are patterns or combinations of patterns. Examples are identifiable statistically repeated patterns as might be found in rock formations, chains of DNA and the like.

The textures are then labeled (Step B) for appropriate identification. The labels serve as a tags for the compressed data resulting from preliminary analysis based on pattern/texture recognition techniques.

The process is furthered by defining the system and its environment, as well as the boundaries between the system and the environment (Step C). The system is the texture to be considered, and the environment is everything that affects the system which is necessary to make the model a closed model where the system is an open system.

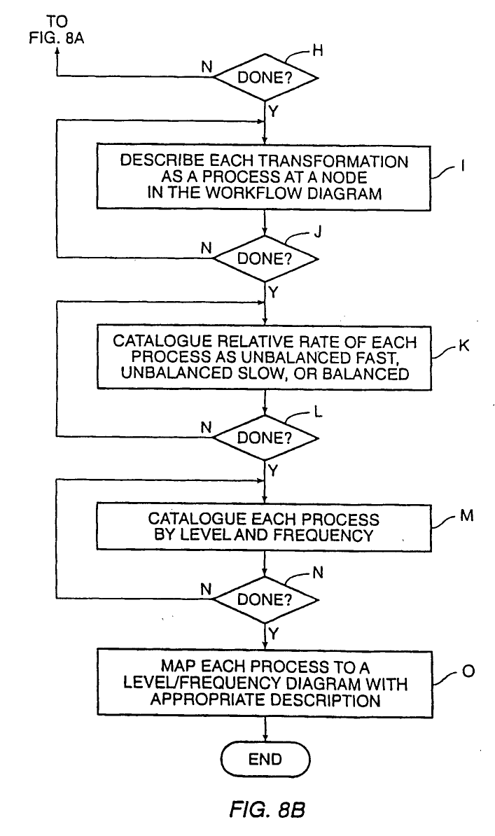

Thereafter comes a description of the workflow of the system (Step D). This workflow must be in terms of sources and sinks of energy and of raw materials, as hereinafter noted in FIGS. 8A and 8B.

Referring to FIGS. 8A and 8B, first, a list of the energy and elementary materials of the system is developed (Step E).

Then, for each member of the list, the points of entry into the system from the environment are identified (Step F). The points of entry are subsets of the labeled textures.

Then, for each point of entry, roots of the points of entry are traced through the system, and points of further transformation, if any, are identified (Step G). Points of further transformation can be fractal level changes, changes in scale, changes in texture, changes in content as by splitting or joining or rearrangements and reordering of content.

When that is done (Step H), the nodes are characterized by their inputs, outputs and transformations (Step I). Each transformation is described as a process in a workflow diagram.

When that is done (Step J), the relative rate of each process is catalogued as either balanced, unbalanced fast or unbalanced slow, in a three state system (Step K). For each level there is a unique temporal behavior. When there is a stationary state defined over the whole system by an interrelated state of balance, the stationary state is defined relative to a lowest interval of time that can be analyzed. If there is an attempted analysis with a finer increment of time, for example, fluctuations away from the stationary state will be observed. At a second order phase transition, these fluctuations have no fixed scale. Since the set points are dynamic, the behavior in approach to repose from fluctuations is also without scale. This is analogous to the observation that avalanches can occur in all scales of piles of rubble, from sand to boulders.

The stationary state is thus characterized statistically as zero error in time, i.e., it will average to zero error on a selected time scale. However, for the characterization in time there will also be a multilevel behavior of the pattern with deviations away from the stationary state.

After the relative rates of the processes have been catalogued (Step L), each process is catalogued by level and frequency (Step M). In other words, a determination is made as to where each process is in the system and how many occurrences of the processes exist within the system.

When that is done (Step N), the model is completed by mapping each process to a level and frequency with appropriate description in the level/frequency diagram (Step O). An example of a level/frequency diagram has been shown in FIG. 5. For each unique processor i (defined by a unique level and frequency), there is a workflow description of the process which is going on. This workflow description is embedded in the processor i, which is an object in an object oriented system.

A key step according to the invention is the cataloguing of the relative rates (Step J). This involves tracking processes through various dimensions, levels and determining which side a process is relative to a locally-defined critical point. This important modeling step requires some external empirically-based input to effect. The selected choice of such a constant determines for example whether a system is self-perpetuating, increasingly oscillatory or decaying. Biological homeostasis is a particularly apt example of a self-perpetuating system where the system must be set at the self-perpetuating critical point.

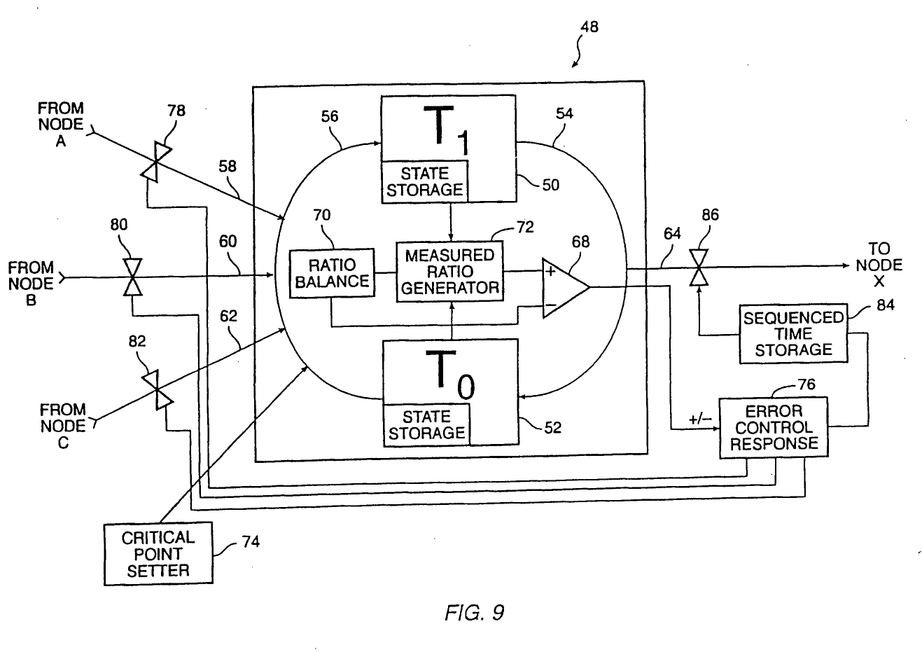

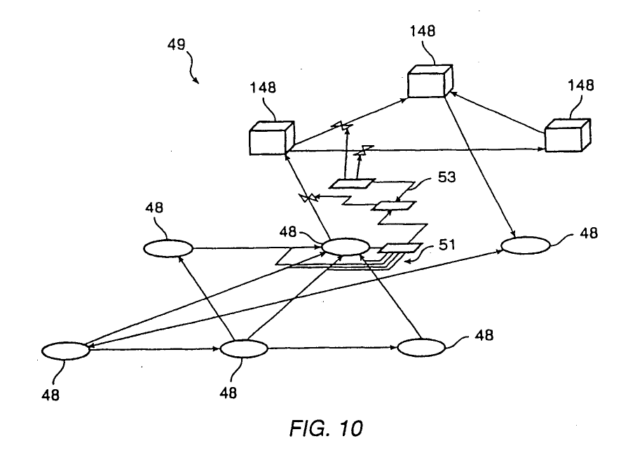

FIG. 9 is a diagram of a generic node representing the basic process 48 according to the invention, and it best illustrates the basic process in all of its temporal manifestations. It is understood that this process is multidimensional and fractal in nature, according to the invention. Input and feedback can be from any fractal level or any associated dimension. The process comprises two stable coexistent states T₁ 50 and T₀ 52 with first generalized activation 54 from T₁ 50 to T₀ 52 and second generalized activation 56 from T₀ 52 to T₁ 50, and one or a plurality of energy and material inputs 58, 60, 62 and an energy and material output 64 (which can always be represented as a single output). The generalized activations 54 and 56 are each a flow of energy and materials. The ratio of the (energy and material) population of state T₁ 50 to state T₀ 52 is constant when the system is stable. For a living system, the process 48 represents homeostasis, that is, life in balance, or steady state. For a generalized physical system, the process represents stationary state. The process 48 is subject to internal self regulation, as hereinafter described, about a preselected local critical point, which serves to establish the local characteristics of the process and thus the ratio of stable states T₁/T₀ which is defined as the steady state. When each local process is at steady state, a global system comprising the totality of local processes is also at steady state. That steady state is, according to the invention, defined as the self-organized critical state, and it is a critical point as found in a second order phase transition. If the global system cannot achieve criticality, then it is not a self-organized critical system. It may well self organize around a first order phase transition, but it is not a self organized critical system, since it lacks a critical point.

The control system which establishes steady state is a feedback system with an error detector 68 for detecting deviations between the preselected ratio balance 70 and the measured ratio balance 72. The error detector 68 controls an amplifier, or error control response subsystem 76, which in turn regulates inputs via valves 78, 80, 82 on inputs A, B and C, and, via a sequence time storage unit 84, a valve 86. (The sequence time storage unit 86 provides the time delay to assure that inputs and output are synchronized.) The preselected ratio balance 70 is established by an external critical point setter 74. The critical point is derived from the boundary conditions, structure and entropy considerations. Given a set of boundary conditions between the internal mechanisms and the environment, the critical point can be calculated using graph theory and thermodynamics, i.e., the Second Law of Thermodynamics. Alternatively, the critical point can be empirically derived by comparing a real system and its corresponding simulation model.

FIG. 10 is a diagram of a multidimensional network 49 of a plurality of nodes (processes) 48 in one dimension and processes 148 in another dimension of the type of FIG. 9. Feedback paths 51, 53 may be across dimensions.

As an example of a model of a system according to the invention, consider the complexity of eukaryotic cell growth. It is postulated from the model according to the invention that there must be an additional level of regulation to balance the growth allowed by the nutritional resources with the organism's need for those cells in the overall system. Cancer is an example of uncontrolled growth of particular classes of cells. When the first cancer-related gene was identified, it was shown to be in a protein that monitored the presence of growth factors and coupled this sensing to the allowable rate of cell growth. When this cancer gene was analyzed to determine if it was related to any known genes in bacteria, it was found to be related to the elongation factor. This relation was in fact found to be due to the same binding of GDP and GTP by the two proteins, namely the elongation factor and the cancer factor RAS. This can be modeled adequately by the present invention. In fact it can be used to model every known regulatory mechanism known to be relevant to cancer.

As another example, cells are made of four classes of macromolecules, namely lipids, carbohydrates, nucleic acids and proteins. While these are important processes according to the definitional structure of the invention, they need not be modeled at a certain level and may well only be treated as input resources to a differently-indexed level of the system. The models of the cells can be subsumed into a subsystem such as an organ for purposes of macro simulation.

It must be understood is that there is a thermodynamic critical point of phase transition associated each dimension of a system. Any system in a stationary or steady state has an inherent thermodynamic critical point related to a throughput of factors of the system. Within the limits of observation, if one can define a conserved quantity in the stationary or steady state of the system, then one can use a dynamic renormalization group calculation to determine exactly (within the limits of observation) the critical exponents which define the critical point in all dimension of phase transition for the self organizing state of the system. Dynamic renormalization group calculation is a process which describes the relationship between levels in a multilevel system, such as atoms, molecules, cells, organs, bodies. A reference which explains how to calculate the critical point is the paper of Hwa and Carter, “Dissipative Transport in Open Systems: An Investigation of Self-Organized Criticality,” Physical Review Letters, Vol. 62, No. 16 (17 Apr. 1989) pp. 1813-1816, the content of which is incorporated by reference. However, the subject matter is not considered an element of this invention.

The simulation technique according to the invention will yield a confirmation of the prediction of the inherent critical point of each closed node whereby a stable system will result. Alternatively it will yield sufficient information to evaluate the deviation from the stationary state in the subject system. For example, in a physiological system, deviations from steady state are deviations from homeostasis which correspond to illnesses.

The invention has been explained with respect to specific embodiments. Other embodiments will be apparent to those of ordinary skill in the art. A technique has been disclosed for simulating complex systems in terms of simple sources, simple sinks and simple nodes with critical points scalable across dimensions. Thus, this invention is not limited, except as indicated by the appended claims.

1. In a computer system, a method for simulating a dynamic system with a plurality of interacting nodes of interest in a network of said nodes of interest, said method comprising:
providing said nodes of interest in said computer system, each node of interest having at least one input, at least one output paired with said at least one input, at least one transformation of inputs, at least one transformation of outputs, a measurable ratio of input transformation rate to output transformation rate of an input/output pair, at least a first activated state in the node corresponding to an excess measurable ratio of input to output, at least a second activated state in the node corresponding to a deficit measurable ratio of input to output, and transient storage of a product of the input; and
for each node of interest, defining a balanced state between said first activated state and said second activated state, said balanced state corresponding to a zero error between said measurable ratio and a preestablished balanced ratio, said preestablished balanced ratio corresponding to a mathematical critical point in thermodynamic energy.

2. In the method according to claim 1 further including the steps of:
for each said node of interest, sensing for non-zero error between said measurable ratio and said preestablished balanced ratio; and
using said non-zero error as a control signal to mediate at least one of said inputs, said outputs and an external process.

3. The method according to claim 2 wherein said node is representative of a living organism and wherein said error signal provides input to a regulating element for regulation to a condition of homeostasis.

4. The method according to claim 2 wherein said node is representative of a non-living system and wherein said error signal is at least an indication of imbalance in energy distribution.
Pathways span multiple elements in a system across multiple dimensions.

5. The method according to claim 2, further including:
establishing pathways between outputs of first selected nodes of interest to inputs of second selected nodes of interest.

6. The method according to claim 2 further including depicting each said four dimensional model in five orthogonal dimensions of space, time and grayscale, said grayscale representing a mapping from a second temporal dimension.

7. The method according to claim 6 further including providing feedback across said five orthogonal dimensions from said old four dimensional model to produce a new four dimensional model, said old four dimensional model and said new four dimensional model together constituting a six dimensional model.

8. The method according to claim 1 wherein said critical point is selected for maximum stability of said balanced state.

9. The method according to claim 1 wherein said critical point is selected in response to sensing said outputs of said nodes.

10. In a computer system, a modeling node for use in simulating a dynamic system in a network of said nodes, said node comprising:
at least one input;
at least one output paired with said at least one input;
at least one transformation of inputs;
at least one transformation of outputs;
a measurable ratio of input transformation rate to output transformation rate of an input/output pair;
at least a first activated state in the node corresponding to an excess measurable ratio of input to output;
at least a second activated state in the node corresponding to a deficit measurable ratio of input to output;
transient storage of a product of the input; and
a balanced state between said first activated state and said second activated state, said balanced state corresponding to a zero error between said measurable ratio and a preestablished balanced ratio, said preestablished balanced ratio corresponding to a mathematical critical point in thermodynamic energy.
